(19) United States
(12) Patent Application Publication
(10) Pub. No.: US 2007/0234084 A1
(43) Pub. Date: Oct. 4, 2007

(54) Information processing apparatus and operation control method

(76) Inventor: Shinichi Furuta, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/728,409

(22) Filed: Mar. 26, 2007

(30) Foreign Application Priority Data
Mar. 28, 2006 (JP) 2006-088145

(51) Int. Cl. G06F 1/00

(52) U.S. Cl. 713/300

(57) ABSTRACT

According to one embodiment, an information processing apparatus includes a receiving device, a processor, and a control unit. The receiving device receives broadcast program data. The processor executes various software, and transitions, when the processor is idle, from an operation state to one of a first sleep state in which the processor consumes less power than in the operation state, and a second sleep state in which the processor consumes less power than in the first sleep state and takes a longer time for restoring to the operation state than in the first sleep state. The control unit prohibits the processor from transitioning to the second sleep state when a program for reproducing the broadcast program data, which is received by the receiving device, is started.

### CROSS-REFERENCE TO RELATED APPLICATIONS

This application is based upon and claims the benefit of priority from Japanese Patent Application No. 2006-088145, filed Mar. 28, 2006, the entire contents of which are incorporated herein by reference.

### BACKGROUND

1. Field

One embodiment of the invention relates to an information processing apparatus such as a personal computer and an operation control method, for example, including a receiving device for receiving broadcast program data.

2. Description of the Related Art

In recent years, various battery-drivable notebook-type or laptop-type portable computers have been developed.

In addition, portable computers having the same AV function as audio-video (AV) apparatuses, such as a DVD (Digital Versatile Disc) player and a TV apparatus, have recently been developed. Most of this kind of computers has a function of receiving and reproducing broadcast program data.

The portable computers are equipped with various power-saving functions for reducing power consumption, thereby to extend the battery-powerable operation time.

Jpn. Pat. Appln. KOKAI Publication No. 2000-32081 discloses a computer system having a power-saving control function which determines whether a mode of communication with an external device, which is executed via a communication port, is a control communication mode or a data communication mode, and permits or prohibits the transition to a power-saving mode on the basis of the result of determination.

In Jpn. Pat. Appln. KOKAI Publication No. 2000-32081, however, no consideration is given to a power-saving control during the reproduction of broadcast program data.

In the computer having the function of reproducing broadcast program data, it is necessary to realize a novel function capable of reducing power consumption of the computer without causing a problem in the operation of reproducing broadcast program data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view that shows a general appearance of an information processing apparatus according to an embodiment of the invention;

FIG. 2 is an exemplary block diagram showing an example of the system configuration of the information processing apparatus according to the embodiment;

FIG. 3 is an exemplary block diagram showing CPU states of a CPU which is provided in the information processing apparatus according to the embodiment;

FIG. 4 shows an example of the functional structure of a BIOS which is executed by the information processing apparatus according to the embodiment;

FIG. 5 is an exemplary flow chart illustrating an example of the procedure of a CPU sleep state control process which is executed by the information processing apparatus according to the embodiment;

FIG. 6 is an exemplary block diagram showing specific examples of the CPU states of the CPU which is provided in the information processing apparatus according to the embodiment;

FIG. 7 shows an example of an interface between a TV application program and the BIOS in the information processing apparatus according to the embodiment; and

FIG. 8 is an exemplary flow chart illustrating an example of the specific procedure of the CPU sleep state control process which is executed by the information processing apparatus according to the embodiment.

### DETAILED DESCRIPTION

Various embodiments according to the invention will be described hereinafter with reference to the accompanying drawings. In general, according to one embodiment of the invention, an information processing apparatus includes a receiving device, a processor, and a control unit. The receiving device receives broadcast program data. The processor executes various software, and transitions, when the processor is idle, from an operation state to one of a first sleep state in which the processor consumes less power than in the operation state, and a second sleep state in which the processor consumes less power than in the first sleep state and takes a longer time for restoring to the operation state than in the first sleep state. The control unit prohibits the processor from transitioning to the second sleep state when a program for reproducing the broadcast program data, which is received by the receiving device, is started.

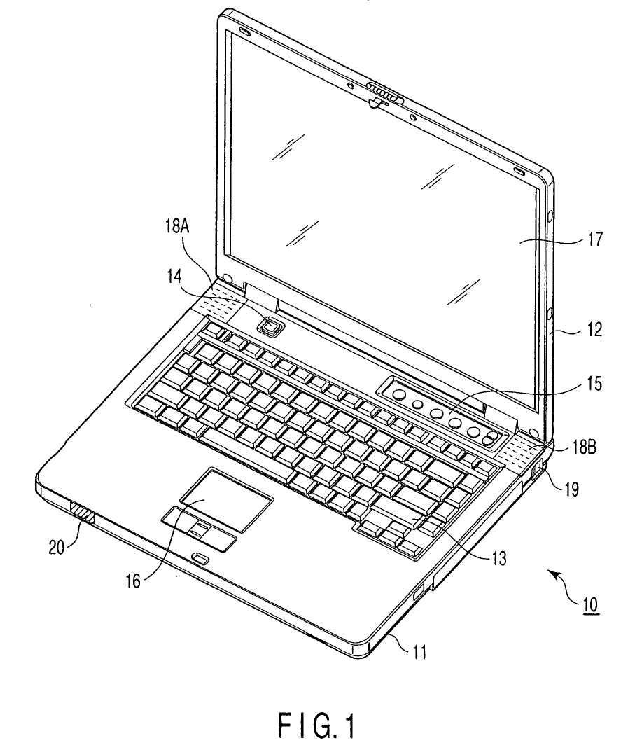

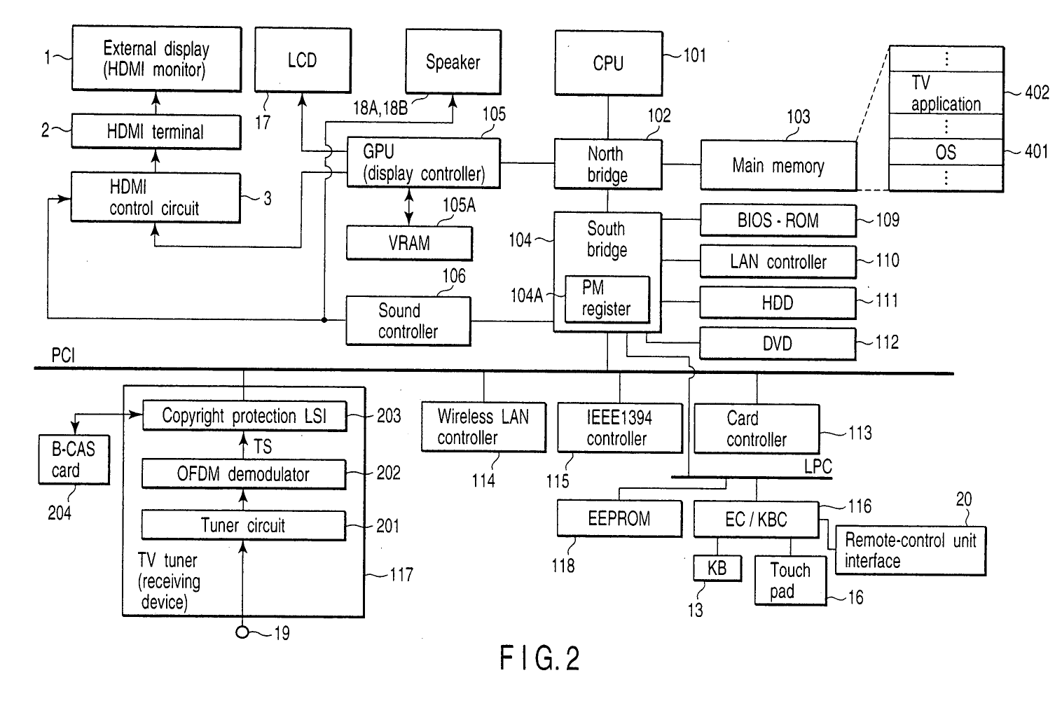

To begin with, referring to FIG. 1 and FIG. 2, the structure of an information processing apparatus according to an embodiment of the invention is described. The information processing apparatus is realized, for example, as a battery-powerable notebook portable personal computer 10.

FIG. 1 is a perspective view that shows the state in which a display unit of the notebook personal computer 10 is opened. The computer 10 comprises a computer main body 11 and a display unit 12. A display device that is composed of a TFT-LCD (Thin Film Transistor Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position where a top surface of the main body 11 is exposed and a closed position where the top surface of the main body 11 is covered by the display unit 12. The computer main body 11 has a thin box-shaped casing. A keyboard 13, a power button 14 for powering on/off the computer 10, an input operation panel 15, a touch pad 16 and speakers 18A, 18B are disposed on the top surface of the computer main body 11.

The input operation panel 15 is an input device that inputs an event corresponding to a pressed button. The input operation panel 15 has a plurality of buttons for activating a plurality of functions. The buttons include an operation button for controlling a TV function for viewing/listening to and recording broadcast program data such as TV broadcast program data.

A remote-control unit interface unit 20, which executes communication with a remote-control unit that controls the TV function of the computer 10, is provided on a front surface of the computer main body 11. The remote-control interface unit 20 is composed of, e.g. an infrared signal receiving unit.

The computer 10 is capable of receiving and reproducing broadcast program data such as TV broadcast program data. An antenna terminal 19 for TV broadcast is provided, for example, on a right side surface of the computer main body 11. In addition, on a rear surface of the computer main body 11, there is provided an external display connection terminal corresponding to, e.g. HDMI (high-definition multimedia interface) standard. The external display connection terminal is used to output a video signal, which corresponds to broadcast program data, to an external display.

Referring now to FIG. 2, the system configuration of the computer 10 is described.

As shown in FIG. 2, the computer 10 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, a DVD drive 112, a card controller 113, a wireless LAN controller 114, an IEEE 1394 controller 115, an embedded controller/keyboard controller IC (EC/KBC) 116, a TV tuner 117, and an EEPROM 118.

The CPU 101 is a processor which controls the operation of the computer 10. The CPU 101 executes an operating system (OS) 401 and various application programs, such as a TV application program 402, which are loaded from the hard disk drive (HDD) 111 into the main memory 103. The TV application program 402 is software for executing a TV function. The TV application program 402 executes, for instance, a reproducing process for reproducing broadcast program data which is received by the TV tuner, and a recording process for storing the received broadcast program data in the HDD 111. The TV application program 402 is started, for example, in response to a user's operation of an operation button in the input operation panel 15, or a user's operation of a remote-control unit. The CPU 101 also executes a system BIOS (Basic Input/Output System) that is stored in the BIOS-ROM 109. The system BIOS is a program for hardware control.

The CPU 101 has a plurality of power states between which the amount of power consumed by the CPU 101 is different. The power states include an operation state (also referred to as “active state”) and a plurality of sleep states.

While the CPU 101 is in the operation state, the CPU 101 executes instructions. On the other hand, while the CPU 101 is in any one of the sleep states, the CPU 101 executes no instruction. When the CPU 101 is idle, the CPU 101 transitions from the operation state to one of the sleep states under the control of the OS 401.

The plurality of sleep states are different in depth. As the CPU 101 enters a sleep state with a greater depth, the power consumption of the CPU 101 becomes smaller. In addition, as the CPU 101 enters a sleep state with a greater depth, a longer time is needed until the CPU 101 exits from the sleep state and restores to the operation state. The OS 401 determines which of the sleep states is to be used when the CPU 101 is idle.

The north bridge 102 is a bridge device that connects a local bus of the CPU 101 and the south bridge 104. The north bridge 102 includes a memory controller that access-controls the main memory 103. The north bridge 102 has a function of executing communication with the GPU 105 via, e.g. a PCI EXPRESS serial bus.

The GPU 105 is a display controller for controlling the LCD 17 that is used as a display device of the computer 10. A video signal, which is generated by the GPU 105, is sent to the LCD 17. In addition, the GPU 105 can send a digital video signal to an external display device 1 via an HDMI control circuit 3 and an HDMI terminal 2.

The HDMI terminal 2 is the above-mentioned external display connection terminal. The HDMI terminal 2 can send both a digital video signal and a digital audio signal via a single cable to the external display device 1 such as a TV.

The HDMI control circuit 3 is an interface for sending the digital video signal to the external display device 1 which is called “HDMI monitor” via the HDMI terminal 2.

The south bridge 104 controls the devices on an LPC (Low Pin Count) bus, and the devices on a PCI (Peripheral Component Interconnect) bus. In addition, the south bridge 104 includes an IDE (Integrated Drive Electronics) controller for controlling the hard disk drive (HDD) 111 and DVD drive 112. The south bridge 104 also includes a function of executing communication with the sound controller 106.

Furthermore, the south bridge 104 includes a power management register (PM register) 104A. The PM register 104A is a memory unit for storing power management information for designating a sleep state with a greatest depth, to which the CPU 111 can transition. The process of setting the power management information in the PM register 104A is executed by the BIOS. Under the control of the OS 401, the CPU 101 can transition to the sleep state with the greatest depth, which is designated by the power management information.

The sound controller 106 is a sound source device, and outputs audio data, which is to be reproduced, to the speakers 18A, 18B or to the HDMI control circuit 3.

The card controller 113 controls card devices such as a PC card and an SD (Secure Digital) card. The wireless LAN controller 114 is a wireless communication device which executes wireless communication of, e.g. IEEE 802.11 standard. The IEEE 1394 controller 115 executes communication with an external device via an IEEE 1394 serial bus.

The embedded controller/keyboard controller IC (EC/KBC) 116 is a 1-chip microcomputer in which an embedded controller for power management and a keyboard controller for controlling the keyboard (KB) 13 and touch pad 16 are integrated. The embedded controller/keyboard controller IC (EC/KBC) 116 has a function of powering on/off the computer 10 in response to the user's operation of the power button 14. Further, the embedded controller/keyboard controller IC (EC/KBC) 116 has a function of executing communication with the remote-control unit interface 20.

The TV tuner 117 is a receiving device which receives broadcast program data such as TV broadcast program data, and is connected to the antenna terminal 19.

The TV tuner 117 is realized, for example, as a digital TV tuner which can receive digital broadcast program data such as ground digital TV broadcast program data. In the digital broadcast program data that is received by the TV tuner 117, broadcast program data (video, audio) of a specified channel and graphics data (e.g. news, weather report), which is provided by, e.g. data broadcast, are multiplexed.

The TV tuner 117 includes a tuner circuit 201, an OFDM (Orthogonal Frequency Division Multiplexing) demodulator 202, and a copyright protection LSI 203.

In the digital TV broadcast, MPEG2 is used as a compression-encoding scheme for broadcast program data (video, audio). In addition, SD (Standard Definition) with a standard resolution and HD (High Definition) with a high resolution can be used as video formats. If the resolution of the TV broadcast program, which is being broadcast, varies, the amount of data, which is received by the TV tuner 117 per unit time, greatly varies. During a time period in which graphics data is being sent from a broadcast station, the amount of data, which is received by the TV tuner 117 per unit time, increases. During a time period in which graphics data is not sent from the broadcast station, the amount of data, which is received by the TV tuner 117 per unit time, decreases.

The tuner circuit 201 and OFDM demodulator 202 function as a tuner unit for receiving broadcast program data. The tuner circuit 201 receives a TV broadcast signal of a specified channel, which is selected from TV broadcast signals which are input from the antenna terminal 19. The OFDM (Orthogonal Frequency Division Multiplexing) demodulator 202 demodulates the TV broadcast signal that is received by the tuner circuit 201, and extracts a transport stream (TS) from the TV broadcast signal. The transport stream is a stream in which broadcast program data (video, audio) and graphics data (e.g. news, weather report), which is provided by data broadcast, are multiplexed. The broadcast program data (video, audio), which is included in the transport stream, is encrypted (scrambled).

The copyright protection LSI 203 includes a buffer for temporarily storing encrypted broadcast program data. The copyright protection LSI 203 executes a process of decrypting the encrypted broadcast program data, which is stored in the buffer, under the control of the TV application program 402.

The decryption of the encrypted broadcast program data is executed by using, for example, a B-CAS card 204 which is mounted in the computer main body 11. The B-CAS card 204 is an IC card which stores information (key, authentication information, contract information, etc.) for decrypting encrypted broadcast program data. The copyright protection LSI 203 decrypts encrypted broadcast program data by using the information that is stored in the B-CAS card 204. In addition, the copyright protection LSI 203 re-encrypts broadcast program data on the basis of a local encryption key which is generated by, e.g. key exchange with the TV application program 402. The encrypted broadcast program data is read out of the copyright protection LSI 203 by the CPU 101.

The TV application program 402 executes a decryption process for decrypting encrypted broadcast program data which is forwarded from the tuner circuit 201, and a reproduction process for reproducing the decrypted broadcast program data. In the reproduction process, the CPU 101 first executes a multiplex process for separating video data, audio data and graphics data from the broadcast program data. The video data, audio data and graphics data are compression-encoded. The TV application program 402 decodes the video data, audio data and graphics data. The decoded audio data is sent to the sound controller 106. The TV application program 402 writes the decoded video data and decoded graphics data in the VRAM 105A, and controls the GPU 105 to cause the GPU 105 to execute a process of mixing the decoded video data and decoded graphics data. The decryption process for releasing the encryption of the received broadcast program data may be executed not by the copyright protection LSI 203, but by the CPU 101, i.e. the TV application program 402.

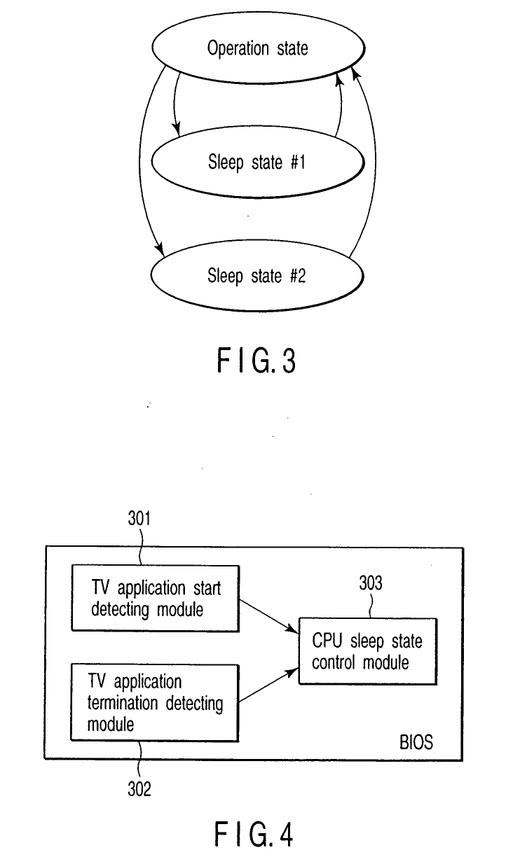

Next, the processor power states are described with reference to FIG. 3.

In FIG. 3, it is assumed that a plurality of sleep states, to which the CPU 101 can transition, include at least a first sleep state (sleep state #1) and a second sleep state (sleep state #2).

Under the control of the OS 401, the CPU 101 is set in one of the operation state, the first sleep state (sleep state #1) and the second sleep state (sleep state #2).

The relationship in power consumption between these processor power states is as follows:

Operation state>Sleep state #1>Sleep state #2.

The relationship in length of time, which is needed for restoration from the sleep states to the operation state, is as follows:

Sleep state #2>Sleep state #1.

Since the CPU 101 has a relatively high computing power, the CPU 101 may temporarily pass into an idle state even while the TV application program 402 is running, that is, even while broadcast program data is being reproduced. Specifically, in the case where the computing power of the CPU 101 exceeds the computation amount that is needed for a process of reproducing broadcast program data in real time, the queue that is managed by a scheduler in the OS 401 may become empty. In this case, in order to reduce the power consumption of the CPU 101, the OS 401 transitions the processor power state of the CPU 101 from the operation state to the sleep state #1 or sleep state #2.

As described above, the time needed for restoration from the sleep state #2 to the operation state is longer than the time needed for restoration from the sleep state #1 to the operation state. Thus, if the OS 401 selects the sleep state #2 as a sleep state to which the CPU 101 is to be transitioned, a predetermined long time is needed from a time when the execution of an instruction by the CPU 101 is halted to a time when the execution of the instruction by the CPU 101 is resumed.

Even while the CPU 101 is in the sleep state, the TV tuner 117 keeps on receiving broadcast program data from the TV tuner 117. Besides, as described above, the amount of data, which is to be received by the TV tuner 117 per unit time, is not fixed and is variable. For example, in a case where the amount of data, which is to be received by the TV tuner 117 per unit time, increases, overflow of data may occur during the standby time in the buffer in the TV tuner 117, that is, the buffer in the copyright protection LSI. As a result, part of the broadcast program data may be lost. In this case, the broadcast program data cannot normally be reproduced due to, e.g. an error in synchronism.

In order to prevent this problem, it is thinkable to provide, for instance, a large-capacity buffer or memory in the TV tuner 117. In this case, however, the manufacturing cost increases, and there is a possibility that broadcast program data which requires copyright protection may unlawfully be copied.

In the present embodiment, the BIOS has a function of prohibiting the CPU 101 from transitioning to the sleep state #2 while the TV application program 402 is running. In this case, the CPU 101 can transition to the sleep state #1, but cannot transition to the sleep state #2. Since the time that is needed for restoring from the sleep state #2 to the operation state is relatively short, the power consumed by the CPU 101 can be saved without overflow of the buffer.

FIG. 4 shows the functional structure of the BIOS.

The BIOS includes, as its function executing modules, a TV application start detecting module 301, a TV application termination detecting module 302 and a CPU sleep state control module 303.

The TV application start detecting module 301 executes a process of determining whether the TV application 402 is started or not. For example, when the TV application program 402 informs the BIOS of a predetermined message indicative of the start of the TV application program 402, the TV application start detecting module 301 detects the start of the TV application program 402.

The TV application termination detecting module 302 executes a process of determining whether the TV application program 402 is finished or not, that is, whether the TV application program 402 is ended or not. For example, when the TV application program 402 informs the BIOS of a predetermined message indicative of the occurrence of an event which finishes the TV application program 402, the TV application termination detecting module 302 detects the finish of the TV application program 402, that is, the end of the TV application program 402.

When it is determined that the TV application program 402 is started, the CPU sleep state control module 303 prohibits the CPU 111 from transitioning to the sleep state #2. Specifically, when it is determined that the TV application program 402 is started, the CPU sleep state control module 303 changes the sleep state with the greatest depth, to which the CPU 111 can transition, from the sleep state #2 to the sleep state #1, thereby prohibiting the CPU 111 from transitioning to the sleep state #2.

In addition, when it is determined that the TV application program 402 is terminated, the CPU sleep state control module 303 permits the CPU 111 to transition to the sleep state #2. Specifically, when it is determined that the TV application program 402 is terminated, the CPU sleep state control module 303 changes the sleep state with the greatest depth, to which the CPU 111 can transition, from the sleep state #1 to the sleep state #2, thereby permitting the CPU 111 to transition to the sleep state #2.

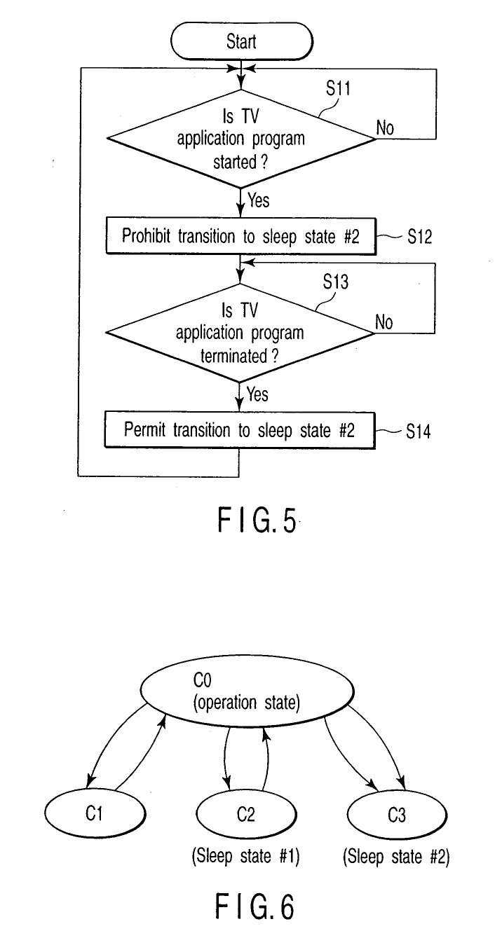

Next, referring to a flow chart of FIG. 5, the procedure of a CPU sleep state control process, which is executed by the BIOS, is described.

To start with, the BIOS determines whether the TV application program 402 is started or not (block S11). If the TV application program 402 is started, the TV application program 402 instructs the TV tuner 117 to receive broadcast program data, and starts the above-described decryption process and reproduction process. In addition, if the TV application program 402 is started, the TV application program 402 informs the BIOS of the start of the TV application program 402. In response to the information, the BIOS detects the start of the TV application program 402.

If it is determined that the TV application program 402 is started (YES in block S11), the BIOS changes the sleep state with the greatest depth, to which the CPU 111 can transition, from the sleep state #2 to the sleep state #1, thereby prohibiting the CPU 111 from transitioning to the sleep state #2 (block S12). In block S12, the BIOS executes a process of setting power management information, which indicates that the sleep state #1 is the sleep state with the greatest depth, in the PM register 104A.

Thereafter, the BIOS determines whether the TV application program 402 is terminated or not (block S13). If an event which terminates the TV application program 402 occurs, the TV application program 402 informs the BIOS that the TV application program 402 is to be terminated. Responding to this information, the BIOS detects the termination of the TV application program 402, that is, the end of the TV application program 402.

If the termination of the TV application program 402 is detected (YES in block S13), the BIOS restores the sleep state with the greatest depth, to which the CPU 111 can transition, from the sleep state #1 to the sleep state #2, thereby permitting the CPU 111 to transition to the sleep state #2 (block S14). In block S14, the BIOS executes a process of setting power management information, which indicates that the sleep state #2 is the sleep state with the greatest depth, in the PM register 104A.

Next, referring to FIG. 6, specific examples of the sleep states #1 and #2 are described.

A specification called Advanced Configuration and Power Interface (ACPI) is known as an example of power management technology for computers.

In the ACPI specification, processor power states C0 to C3 are defined.

In the present embodiment, the operation state of the CPU 111 is realized, for example, by using the processor power state C0 defined by the ACPI standard. While the CPU 111 is in the operation state, that is, in the processor power state C0, the CPU 111 executes instructions.

C1 to C3 are sleep states. While the CPU 111 is in state C1, C2 or C3, the CPU 111 executes no instruction.

The processor power state C1 is realized by using a halt instruction. In the processor power state C2, for example, the frequency of a clock signal, which is supplied to the CPU 111, is decreased. In the processor power state C3, for example, not only the frequency of a clock signal, which is supplied to the CPU 111, is decreased, but also the value of the power supply voltage, which is supplied to the CPU 111, is decreased. In short, C3 is a sleep state in which the value of the power supply voltage that is supplied to the CPU 111 is lower than in C2.

The relationship in power consumption between C0, C1, C2 and C3 is as follows:

C0>C1>C2>C3.

The relationship in length of time, which is needed for restoration from C1, C2 and C3 to C0, is as follows:

C3>C2>C1.

If an interrupt signal, such as a timer interrupt which is managed by the OS 401, is generated while the CPU 111 is in the state C1, C2 or C3, the CPU 111 restores from C1, C2 or C3 to C0. In C3, the value of the power supply voltage that is supplied to the CPU 111 is decreased. Thus, when the processor power state is restored from C3 to C0, it is necessary to execute a power supply sequence for restoring the value of the power supply voltage, which is supplied to the CPU 111, to the original value. Thus, a relatively long time is consumed for the restoration from C3 to C0.

The sleep state #1 is realized, for example, by the processor power state C2, and the sleep state #2 is realized, for example, by the processor power state C3.

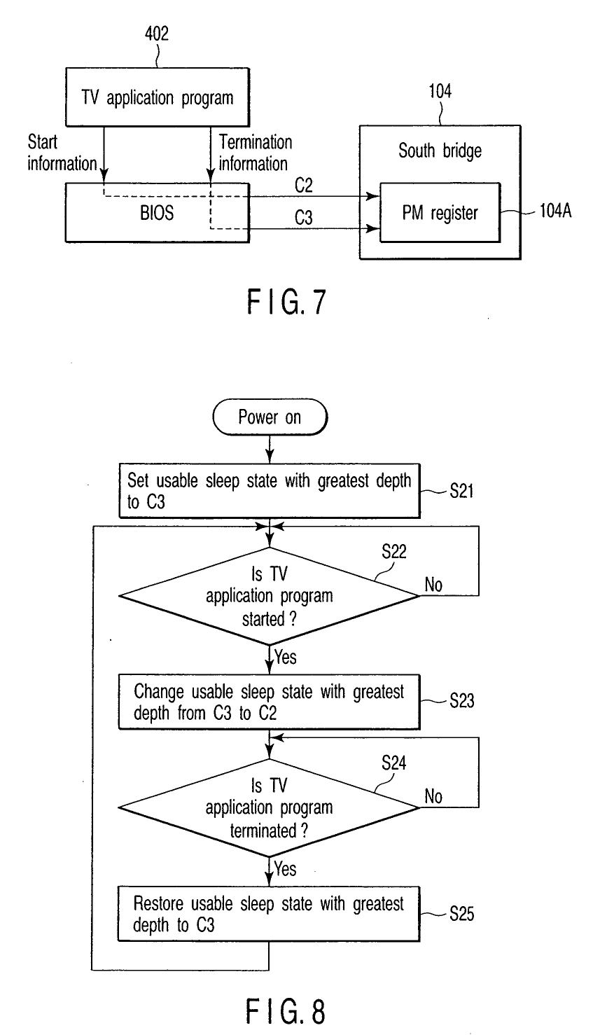

FIG. 7 shows an example of an interface between the TV application program 402 and the BIOS.

If the TV application program 402 is started, the TV application program 402 executes a process of causing the TV tuner 117 to start reception of broadcast program data, and a process of informing the BIOS of the start of the TV application program 402. Upon detecting the start of the TV application program 402, the BIOS sets in the PM register 104A the power management information which indicates that the sleep state with the greatest depth, to which the CPU 111 can transition, is the sleep state #1 (e.g. processor power state C2), thereby prohibiting the CPU 111 from transitioning to the sleep state #2 (e.g. processor power state C3) which is deeper than the sleep state #1.

If an event which instructs the termination of the TV application program 402 occurs, the TV application program 402 informs the BIOS that the TV application program 402 is to be terminated. If the BIOS detects that the TV application program 402 is to be terminated, the BIOS sets in the PM register 104A the power management information which indicates that the sleep state with the greatest depth, to which the CPU 111 can transition, is the sleep state #2 (e.g. processor power state C3), thereby permitting the CPU 111 to transition to the sleep state #2 (e.g. processor power state C3) which is deeper than the sleep state #1.

Next, referring to a flow chart of FIG. 8, a description is given of an example of the specific procedure of the CPU sleep state control process which is executed by the BIOS.

If the computer 10 is powered on, the BIOS executes, in the named order, for example, a power-on self test (POST) process for initializing various hardware components, and a process of booting up the OS 401. In the POST process, for example, the BIOS executes a process for setting the sleep state with the greatest depth, to which the CPU 111 can transition, at C3, thereby permitting the CPU 111 to transition to C3 (block S21). In block S21, the BIOS sets in the PM register 104A the power management information which indicates that the sleep state with the greatest depth, to which the CPU 111 can transition, is C3.

After the OS 401 is booted up, the BIOS determines whether the TV application program 402 is started or not (block S22). If it is determined that the TV application program 402 is started (YES in block S22), the BIOS changes the sleep state with the greatest depth, to which the CPU 111 can transition, from C3 to C2, thereby prohibiting the CPU 111 from transitioning to C3 (block S23). In block S23, the BIOS sets in the PM register 104A the power management information which indicates that the sleep state with the greatest depth, to which the CPU 111 can transition, is C2.

Subsequently, the BIOS determines whether the TV application program 402 is terminated or not (block S24). If it is determined that the TV application program 402 is terminated (YES in block S24), the BIOS restores the sleep state with the greatest depth, to which the CPU 111 can transition, to C3, thereby permitting once again the CPU 111 to transition to C3 (block S25). In block S25, the BIOS sets in the PM register 104A the power management information which indicates that the sleep state with the greatest depth, to which the CPU 111 can transition, is C3.

By the above-described CPU sleep state control process, the CPU 111 can be prohibited from transitioning to C3, only while the broadcast program data is being reproduced. In time periods other than the time period in which the broadcast program data is being reproduced, the CPU 111 can transition to C3. Therefore, the power consumption of the CPU 111 can be reduced without causing a problem in the reproduction of broadcast program data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a receiving device which receives broadcast program data;
a processor which executes various software, and transitions, when the processor is idle, from an operation state to one of a first sleep state in which the processor consumes less power than in the operation state, and a second sleep state in which the processor consumes less power than in the first sleep state and takes a longer time for restoring to the operation state than in the first sleep state; and
a control unit which prohibits the processor from transitioning to the second sleep state when a program for reproducing the broadcast program data, which is received by the receiving device, is started.

2. The information processing apparatus according to claim 1, wherein the control unit includes means for determining whether the program is started or not, and means for setting, if it is determined that the program is started, a sleep state with a greatest depth, to which the processor is able to transition, to the firstly sleep state, thereby to prohibit the processor from transitioning to the second sleep state.

3. The information processing apparatus according to claim 1, wherein the control unit permits the processor to transition to the second sleep state when the program is terminated.

4. The information processing apparatus according to claim 1, wherein the control unit includes means for determining whether the program is started or not, means for changing, if it is determined that the program is started, a sleep state with a greatest depth, to which the processor is able to transition, from the second sleep state to the first sleep state, thereby to prohibit the processor from transitioning to the second sleep state, means for determining whether the program is terminated or not, and means for restoring, if it is determined that the program is terminated, the sleep state with the greatest depth, to which the processor is able to transition, from the first sleep state to the second sleep state, thereby to permit the processor to transition to the second sleep state.

5. The information processing apparatus according to claim 1, wherein a value of a power supply voltage, which is supplied to the processor in the second sleep state, is lower than a value of the power supply voltage which is supplied to the processor in the first sleep state.

6. The information processing apparatus according to claim 1, wherein the control unit includes means for setting, after the information processing apparatus is powered on, a sleep state with a greatest depth, to which the processor is able to transition, to the second sleep state, thereby to permit the processor to transition to the second sleep state, means for determining whether the program is started or not, means for changing, if it is determined that the program is started, the sleep state with the greatest depth, to which the processor is able to transition, from the second sleep state to the first sleep state, thereby to prohibit the processor from transitioning to the second sleep state, means for determining whether the program is terminated or not, and means for restoring, if it is determined that the program is terminated, the sleep state with the greatest depth, to which the processor is able to transition, from the first sleep state to the second sleep state, thereby to permit the processor to transition to the second sleep state.

7. The information processing apparatus according to claim 1, wherein the broadcast program data, which is received by the receiving device, is digital broadcast data in which program data of a specified channel and graphics data are multiplexed.

8. An operation control method for controlling an information processing apparatus, the information processing apparatus including a receiving device which receives broadcast program data, and a processor which executes various software, and transitions, when the processor is idle, from an operation state to one of a first sleep state in which the processor consumes less power than in the operation state, and a second sleep state in which the processor consumes less power than in the first sleep state and takes a longer time for restoring to the operation state than in the first sleep state, the method comprising:
determining whether a program for reproducing the broadcast program data, which is received by the receiving device, is started or not; and
prohibiting the processor from transitioning to the second sleep state when it is determined that the program is started.

9. The operation control method according to claim 8, further comprising:
determining whether the program is terminated or not; and
permitting, if it is determined that the program is terminated, the processor to transition to the second sleep state.

10. The operation control method according to claim 8, further comprising setting, after the information processing apparatus is powered on, a sleep state with a greatest depth, to which the processor is able to transition, to the second sleep state, thereby to permit the processor to transition to the second sleep state.
